(19) United States
(12) Patent Application Publication
(10) Pub. No.: US 2013/0164650 A1
(43) Pub. Date: Jun. 27, 2013

(54) MEMBRANE ELECTRODE ASSEMBLY FOR DIRECT OXIDATION FUEL CELL AND DIRECT OXIDATION FUEL CELL USING THE SAME

(71) Applicants: Hideyuki Ueda, Osaka (JP); Hiroaki Matsuda, Osaka (JP)

(72) Inventors: Hideyuki Ueda, Osaka (JP); Hiroaki Matsuda, Osaka (JP)

(73) Assignee: PANASONIC CORPORATION, Osaka (JP)

(21) Appl. No.: 13/820,735

(22) PCT Filed: Jul. 9, 2012
(86) PCT No.: PCT/JP2012/004430

§ 371 Date: Mar. 4, 2013

(30) Foreign Application Priority Data
Jul. 19, 2011 (JP) 2011-157443

(51) Int. Cl. H01M 8/10

(52) U.S. Cl. CPC H01M 8/1004
USPC 429/480

(57) ABSTRACT

Disclosed is a membrane electrode assembly for a direct oxidation fuel cell, including an anode, a cathode, and an electrolyte membrane disposed therebetween. The anode includes an anode catalyst layer disposed on one principal surface of the electrolyte membrane, and an anode diffusion layer laminated on the anode catalyst layer. The anode catalyst layer includes a first particulate conductive carbon, an anode catalyst supported thereon, and a first polymer electrolyte. The cathode includes a cathode catalyst layer disposed on the other principal surface of the electrolyte membrane, and a cathode diffusion layer laminated on the cathode catalyst layer. The cathode catalyst layer includes a second particulate conductive carbon, a cathode catalyst supported thereon, and a second polymer electrolyte. The weight ratio M₁ of the first polymer electrolyte in the anode catalyst layer is higher than the weight ratio M₂ of the second polymer electrolyte in the cathode catalyst layer.

### TECHNICAL FIELD

The present invention relates to a membrane electrode assembly including an anode, a cathode, and an electrolyte membrane disposed therebetween, for a direct oxidation fuel cell, and specifically to an improvement of the catalyst layers included in the anode and the cathode.

### BACKGROUND ART

Energy systems using fuel cells have been proposed as means for solving the environmental problems such as global warming and air pollution and the problems of depletion of resources so that a sustainable recycling society can be realized.

There are various forms of fuel cells, such as stationary fuel cells installed in factories and houses, and non-stationary fuel cells used as a power source for automobiles, portable electronic devices, etc. As compared with power generators employing gasoline engines, fuel cells are quiet in operation and emit no air pollutant gas. Therefore, also for use as an emergency power source in case of disaster and a portable power source for leisure use, fuel cells are expected to be put into practical use as early as possible.

Among them, special attention is paid on direct oxidation fuel cells using an organic liquid fuel such as methanol or dimethyl ether by directly supplying it without reforming into hydrogen gas, to the anode. Organic liquid fuels have a high theoretical energy density and are easy to store, and therefore, the fuel cell system can be easily simplified by using an organic liquid fuel.

Direct oxidation fuel cells have a unit cell comprising a pair of separators and a membrane electrode assembly (MEA) disposed therebetween. The MEA includes an electrolyte membrane, and an anode and a cathode arranged on both sides thereof. The anode and the cathode each include a catalyst layer and a diffusion layer. A fuel and water are supplied to the anode, and an oxidant (e.g. oxygen gas or air) is supplied to the cathode.

For example, the electrode reactions in a direct methanol fuel cell (DMFC) using methanol as the fuel are represented by the following reaction formulae (1) and (2).

Anode: CH₃OH+H₂O→CO₂+6H⁺+6e⁻ (1)

Cathode: 3/2O₂+6H⁺+6e⁻→3H₂O (2)

At the anode, methanol reacts with water to produce carbon dioxide, protons, and electrons. The protons pass through the electrolyte membrane and reach the cathode, while the electrons reach the cathode via an external circuit. At the cathode, oxygen gas reacts with the protons and electrons to produce water. Oxygen supplied to the cathode is introduced, for example, from the air.

However, there are some problems as below in putting direct oxidation fuel cells such as DMFCs into practical use.

Water produced at the cathode and water having moved from the anode through the electrolyte membrane will accumulate with the passage of power generation time, in a liquid state within the cathode catalyst layer and at the interface between the cathode catalyst layer and the cathode diffusion layer. If water accumulates excessively, the diffusion of oxidant in the cathode catalyst layer is slowed, to increase the concentration overvoltage at the cathode catalyst layer. This is presumably the primary cause of initial deterioration of the power generation performance of DMFCs.

Initial deterioration of DMFCs is affected not only by water accumulation at the cathode but also by methanol crossover (hereinafter referred to as “MCO”), i.e., a phenomenon in which methanol supplied as a fuel passes in an unreacted state through the electrolyte membrane and reaches the cathode. At the cathode catalyst layer, in addition to the reaction represented by the above formula (2), an oxidation reaction of the crossovered methanol occurs. Particularly when the fuel is a high-concentration methanol aqueous solution, the amount of MCO tends to increase with the passage of power generation time, and therefore, the cathode activation overvoltage is likely to increase. Furthermore, carbon dioxide produced by the oxidation reaction of methanol further slows the diffusion of oxidant, and accelerates the deterioration of power generation performance.

When MCO occurs, the polymer electrolyte swells with methanol, and the porosity of the catalyst layer and the like tends to decrease. In view of reducing the influence by such swelling of the polymer electrolyte, the following proposals are made for the material and structure of the anode or cathode catalyst layer.

Patent Literature 1 proposes that, in a DMFC using an aqueous methanol solution having a concentration of 3 mol/L or more as the fuel, the weight ratio of the polymer electrolyte to the catalyst support in the cathode catalyst layer be set to 0.2 to 0.55, and the porosity of the cathode catalyst layer in a dry state be set to 50 to 85%. This proposal intends to ensure the porosity of the cathode catalyst layer even when MCO occurs to cause the polymer electrolyte in the cathode catalyst layer to swell significantly. By allowing the cathode catalyst layer to have a sufficient porosity, the proton conductivity, the oxidant diffusibility, and the ability to discharge water are improved in a well-balanced manner, and excellent long life characteristics can be obtained.

Patent Literature 2 proposes that the weight ratio of the catalyst particles/polymer electrolyte in the anode catalyst layer be set to 3/1 to 20/1. This proposal intends to suppress catalyst poisoning by carbon monoxide which is to be produced in the process of oxidation of methanol, thereby to improve the durability.

Patent Literature 3 proposes that at least one of the anode and cathode catalyst layers be formed in a two-layer structure, and the amount of polymer electrolyte in the diffusion layer-side catalyst layer be set larger than that in the electrolyte membrane-side catalyst layer. This proposal intends to improve the proton conductivity of the catalyst layer, thereby to increase the battery output.

### CITATION LIST

### Patent Literature

[PTL 1] Japanese Laid-Open Patent Publication No. 2010-244791
[PTL 2] Japanese Laid-Open Patent Publication No. 2008-4402
[PTL 3] Japanese Laid-Open Patent Publication No. 2009-238499

### SUMMARY OF INVENTION

### Technical Problem

Initial deterioration of a DMFC occurs on the cathode side. The deterioration, however, is greatly affected not only by the composition of the cathode catalyst layer but also by the composition and pore structure of the anode catalyst layer. If the operation of the fuel cell is started and stopped repeatedly while the fuel is not uniformly diffused in the anode catalyst layer or is not sufficiently supplied in part due to the entry of air on the anode side, the anode potential tends to increase locally. As a result, ruthenium (Ru) serving as the anode catalyst dissolves and passes through the electrolyte membrane, and then deposits as a Ru oxide at the cathode catalyst layer. Excessive deposition of the Ru oxide will degrade the oxygen reduction performance of platinum (Pt) contained in the cathode catalyst layer, resulting in deterioration of the DMFC. In view of suppressing such deterioration, it is important to control the balance between the compositions of the anode catalyst layer and the cathode catalyst layer.

None of Patent Literatures 1 to 3 notes the relative relationship between the amount of polymer electrolyte in the anode catalyst layer and that in the cathode catalyst layer. If, however, the balance therebetween is lost, the performance of the fuel cell would deteriorate. For example, if the weight ratio of polymer electrolyte in the anode catalyst layer is low, the electrode reaction represented by the above formula (1) is unlikely to proceed, to consume a smaller amount of methanol, and the amount of MCO tends to increase. The larger the amount of MCO is, the more easily the polymer electrolyte in the cathode catalyst layer swells with methanol. Due to swelling, the pores in the cathode are decreased, which, for example, slows the diffusion of oxidant, and as a result, the power generation performance of the fuel cell deteriorates. Here, if the weight ratio of polymer electrolyte in the cathode catalyst layer is high, the influence of the swelling with methanol becomes more severe, and the power generation performance and durability of the fuel cell deteriorate more severely. It is therefore desirable to increase or decrease the amount of polymer electrolyte in the cathode catalyst layer, depending on the amount of polymer electrolyte in the anode catalyst layer.

### Solution to Problem

The present invention intends to provide a membrane electrode assembly for a direct oxidation fuel cell and a direct oxidation fuel cell which are excellent in both power generation characteristics and durability.

A membrane electrode assembly for a direct oxidation fuel cell according to one aspect of the present invention includes an anode, a cathode, and an electrolyte membrane disposed between the anode and the cathode. The anode includes an anode catalyst layer disposed on one principal surface of the electrolyte membrane, and an anode diffusion layer laminated on the anode catalyst layer. The anode catalyst layer includes a first particulate conductive carbon, an anode catalyst supported on the first particulate conductive carbon, and a first polymer electrolyte. The cathode includes a cathode catalyst layer disposed on the other principal surface of the electrolyte membrane, and a cathode diffusion layer laminated on the cathode catalyst layer. The cathode catalyst layer includes a second particulate conductive carbon, a cathode catalyst supported on the second particulate conductive carbon, and a second polymer electrolyte. A weight ratio M₁ of the first polymer electrolyte in the anode catalyst layer is higher than a weight ratio M₂ of the second polymer electrolyte in the cathode catalyst layer.

A direct oxidation fuel cell according to another aspect of the present invention includes at least one unit cell which includes the above membrane electrode assembly, an anode-side separator in contact with the anode, and a cathode-side separator in contact with the cathode.

### Advantageous Effects of Invention

According to the present invention, it is possible to provide a membrane electrode assembly for a direct oxidation fuel cell and a direct oxidation fuel cell which are excellent in both power generation characteristics and durability. The direct fuel cell according to the present invention is particularly effective when using an aqueous methanol solution with high concentration, as the fuel.

### BRIEF DESCRIPTION OF DRAWINGS

FIG. 1 A schematic longitudinal cross-sectional view of the configuration of a unit cell included in a direct oxidation fuel cell according to one embodiment of the present invention

FIG. 2 A schematic longitudinal cross-sectional view of an anode catalyst layer included in the direct oxidation fuel cell of FIG. 1

FIG. 3 A series of schematic diagrams for explaining the principle of the measurement of a pore throat size distribution with a perm porometer

FIG. 4 A graph for explaining the principle of the measurement of a pore throat size distribution

FIG. 5 A graph for explaining the principle of the measurement of a pore throat size distribution

FIG. 6 A graph for explaining the pore throat size distribution measured with a perm porometer

FIG. 7 A schematic illustration of an exemplary configuration of a spray coater used for forming an anode catalyst layer and a cathode catalyst layer

### DESCRIPTION OF EMBODIMENT

A membrane electrode assembly for a direct oxidation fuel cell according to the present invention includes an anode, a cathode, and an electrolyte membrane disposed therebetween. The anode includes an anode catalyst layer disposed on one principal surface of the electrolyte membrane, and an anode diffusion layer laminated on the anode catalyst layer. The anode catalyst layer includes a first particulate conductive carbon, an anode catalyst supported thereon, and a first polymer electrolyte. The cathode includes a cathode catalyst layer disposed on the other principal surface of the electrolyte membrane, and a cathode diffusion layer laminated on the cathode catalyst layer. The cathode catalyst layer includes a second particulate conductive carbon, a cathode catalyst supported thereon, and a second polymer electrolyte.

When the weight ratio of polymer electrolyte in the catalyst layer is high, the proton conductivity of the catalyst layer improves. In addition, the conductive carbon particles are easily deaggregated, increasing the electrode reaction area. Particularly at the anode, when the weight ratio of the first polymer electrolyte is excessively low, a smaller amount of methanol is consumed by the electrode reaction, and the amount of MCO tends to increase.

On the other hand, when the weight ratio of polymer electrolyte is excessively high, the pores in the catalyst layer decrease, because polymer electrolytes easily swell with liquid fuel such as methanol. Particularly at the cathode, the larger the amount of MCO is, the more the pores in the catalyst layer decrease. If the pores in the catalyst layer decrease excessively, the diffusion of oxidant gas is slowed, and the power generation performance deteriorates. It is therefore desirable to increase or decrease the weight ratio of the second polymer electrolyte in the cathode catalyst layer, depending on the increase or decrease of the amount of MCO, i.e., the weight ratio of the first polymer electrolyte in the anode catalyst layer.

In view of the above, in the present invention, a weight ratio M₁ of the first polymer electrolyte in the anode catalyst layer is set higher than a weight ratio M₂ of the second polymer electrolyte in the cathode catalyst layer. By setting like this, methanol is sufficiently consumed by the electrode reaction at the anode catalyst layer, and at the cathode catalyst layer, the swelling of the second polymer electrolyte with crossovered methanol is suppressed. Particularly in a fuel cell configured to include a smaller amount of anode catalyst and use a high-concentration methanol aqueous solution as the fuel, the amount of MCO tends to increase comparatively. According to the present invention, it is possible to sufficiently suppress the decrease of the pores due to the swelling of the second polymer electrolyte even in such a configuration, and therefore possible to provide a direct oxidation fuel cell with excellent durability in which the oxidant diffusibility at the cathode catalyst layer is good and the concentration overvoltage is small.

The “weight ratio M₁ of the first polymer electrolyte in the anode catalyst layer” is a ratio of the weight of the first polymer electrolyte to the total weight of the first particulate conductive carbon, anode catalyst, and first polymer electrolyte. M₁ is determined, for example, by the following method.

The anode catalyst layer of a given size (e.g., 1 cm²) is heated with aqua regia to dissolve the anode catalyst layer, to give a solution. The weight of each element contained in the resultant solution is measured by ICP emission spectrometry, whereby M₁ can be determined. The “weight ratio M₂ of the second polymer electrolyte in the cathode catalyst layer” is a ratio of the weight of the second polymer electrolyte to the total weight of the second particulate conductive carbon, cathode catalyst, and second polymer electrolyte. M₂ is determined in the same manner as M₁ is determined, except for using the cathode catalyst layer of a given size in place of the anode catalyst layer.

M₁ is preferably 26 to 35 wt %. In such an anode catalyst layer, the amount of the first polymer electrolyte is relatively large, as compared with the amount of the anode catalyst and the amount of the first particulate conductive carbon. By setting like this, deaggregation of the first particulate conductive carbon is facilitated, ensuring a sufficient electrode reaction area. As a result, even when the amount of the anode catalyst is comparatively small, methanol is sufficiently consumed by the electrode reaction on the anode side, resulting in a small amount of MCO. In addition, since the electrode reaction area of the anode catalyst can be sufficiently ensured, a local increase in anode potential is unlikely to occur, and thus, the dissolution of Ru can be reduced. Consequently, the deposition of Ru oxide at the cathode catalyst layer is unlikely to occur, and the deterioration in the oxygen reduction performance of Pt serving as the cathode catalyst can be suppressed.

When M₁ is less than 26 wt %, the electrode reaction area of the anode catalyst may become insufficient, which may increase the amount of Ru oxide deposited at the cathode catalyst layer. On the other hand, when M₁ is more than 35 wt %, the influence of the swelling of the first polymer electrolyte may become severe. As a result, the fuel diffusibility and the ability to discharge carbon dioxide may degrade. M₁ is more preferably 28 to 33 wt % because this can sufficiently reduce the amount of MCO, and significantly suppress the deposition of Ru oxide.

M₂ is preferably 16 to 22 wt %. When M₂ is less than 16 wt %, the proton conductivity of the cathode catalyst layer may not be sufficiently ensured. On the other hand, when M₂ is more than 22 wt %, the influence of the swelling of the second polymer electrolyte may become more severe. This may result in a slower diffusion of oxidant gas. In view of achieving the proton conductivity and the oxidant gas diffusibility in a well-balanced manner, M is more preferably 17 to 21 wt %.

The difference (M₁−M₂) between M₁ and M₂ is preferably 4 to 16 wt %. When (M₁−M₂) is less than 4 wt %, the amount of the second polymer electrolyte relative to the amount of MCO may become excessively large, causing the cathode to swell easily. On the other hand, when (M₁−M₂) is more than 16 wt %, i.e., for example, M₁ is excessively high or M₂ is excessively low, the balance between the compositions of the anode catalyst layer and the cathode catalyst layer is lost, and the power generation performance of the fuel cell may deteriorate.

A membrane electrode assembly for a direct oxidation fuel cell according to one embodiment of the present invention and a direct oxidation fuel cell using the same are described below with reference to the appended drawings.

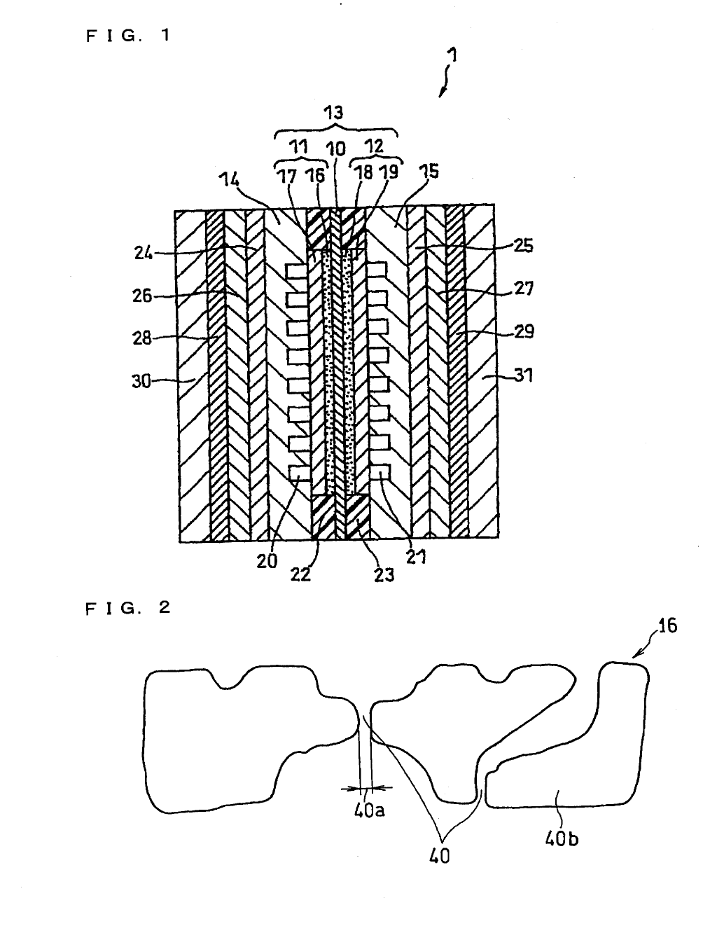

FIG. 1 is a schematic longitudinal cross-sectional view of the configuration of a unit cell included in a direct oxidation fuel cell according to one embodiment of the present invention.

A unit cell 1 of FIG. 1 includes: a membrane electrode assembly (MEA) 13 comprising an electrolyte membrane 10, and an anode 11 and a cathode 12 sandwiching the electrolyte membrane 10; and an anode-side separator 14 and a cathode-side separator 15 sandwiching the MEA 13.

The anode 11 includes an anode catalyst layer 16 and an anode diffusion layer 17. The anode catalyst layer 16 is laminated on the electrolyte membrane 10, and the anode diffusion layer 17 is laminated on the anode catalyst layer 16. The anode diffusion layer 17 is in contact with the anode-side separator 14.

The cathode 12 includes a cathode catalyst layer 18 and a cathode diffusion layer 19. The cathode catalyst layer 18 is laminated on the electrolyte membrane 10, and the cathode diffusion layer 19 is laminated on the cathode catalyst layer 18. The cathode diffusion layer 19 is in contact with the cathode-side separator 15.

The anode-side separator 14 has on its surface facing the anode 11 a fuel flow channel 20 for supplying a fuel and discharging an unused fuel and reaction products. The cathode-side separator 15 has on its surface facing the cathode 12 an oxidant flow channel 21 for supplying an oxidant and discharging an unused oxidant and reaction products. The oxidant may be oxygen gas or a mixed gas containing oxygen gas. The mixed gas is, for example, air.

Around the anode 11, an anode-side gasket 22 is disposed so as to seal the anode 11. Likewise, around the cathode 12, a cathode-side gasket 23 is disposed so as to seal the cathode 12. The anode-side gasket 22 faces the cathode-side gasket 23 with the electrolyte membrane 10 therebetween. The anode-side and cathode-side gaskets 22 and 23 prevent the fuel, oxidant, and reaction products from leaking outside.

The unit cell 1 of FIG. 1 further includes current collector plates 24 and 25, sheet heaters 26 and 27, insulator plates 28 and 29, and end plates 30 and 31, which are disposed on both sides of the separators 14 and 15. The unit cell 1 is integrally held by clamping means (not shown).

The anode catalyst layer 16 is mainly composed of a first particulate conductive carbon (catalyst support) supporting an anode catalyst, and a first polymer electrolyte. The anode catalyst may be, for example, platinum (Pt)-ruthenium (Ru) fine particles. The average particle diameter of the anode catalyst is preferably 1 to 3 nm. The first particulate conductive carbon may be any known material in the art such as carbon black. The average particle diameter of primary particles of the first particulate conductive carbon is preferably 10 to 50 nm.

The cathode catalyst layer 18 is mainly composed of a second particulate conductive carbon (catalyst support) supporting a cathode catalyst, and a second polymer electrolyte. The cathode catalyst may be, for example, platinum (Pt) fine particles. The average particle diameter of the cathode catalyst is preferably 1 to 3 nm. The second particulate conductive carbon may be any known material in the art such as carbon black. The average particle diameter of primary particles of the second particulate conductive carbon is preferably 10 to 50 nm.

The first and second polymer electrolytes are both preferably excellent in proton conductivity, heat resistance, chemical stability, and resistance to swelling with methanol.

The difference |(IEC₁−IEC₂)| between an ion exchange capacity IEC₁ of the first polymer electrolyte and an ion exchange capacity IEC₂ of the second polymer electrolyte is preferably equal to or less than 0.2 meq/g. The ion exchange capacity IEC is an amount of ion exchange groups (expressed in milliequivalent) contained in 1 g of dry polymer.

When |(IEC₁−IEC₂)| is set to be equal to or less than 0.2 meq/g, the proton conductivity of the catalyst layer can be easily controlled. Furthermore, the swelling with liquid fuel of the polymer electrolyte in each catalyst layer can be easily controlled by the weight ratio of the polymer electrolyte amount.

IEC₁ and IEC₂ are each preferably 0.9 to 1.1 meq/g. This allows for achievement of high levels of proton conductivity and resistance to swelling with an aqueous methanol solution of the polymer electrolyte.

At least one of the first polymer electrolyte and the second polymer electrolyte is preferably a perfluorocarbon sulfonic acid polymer, because such polymer electrolyte has excellent chemical stability and electrochemical stability. More preferably, both the first polymer electrolyte and the second polymer electrolyte are a perfluorocarbon sulfonic acid polymer.

The amount of the anode catalyst (Pt—Ru fine particles) per projected unit area cm² of the anode catalyst layer 16 is preferably 1 to 4 mg, and more preferably 2.5 to 4 mg. Since the first particulate conductive carbon is present as aggregates of primary particles, the anode catalyst layer 16 is made more porous. Moreover, in the present invention, since the weight ratio of the first polymer electrolyte is set higher than that of the second polymer electrolyte, the first particulate conductive carbon is easily deaggregated. As such, even when the amount of the anode catalyst per projected unit area cm² of the anode catalyst layer 16 is set to be comparatively small, i.e., 1 to 4 mg, the three-phase interfaces serving as the electrode reaction sites can be sufficiently ensured. Consequently, the increase in anode overvoltage can be suppressed.

The “projected unit area of the catalyst layer” is an area calculated using the contour of the catalyst layer as viewed in the direction normal to the principal surface of the catalyst layer. For example, when the contour of the catalyst layer as viewed in the normal direction is rectangular, the projected unit area can be calculated from (length)×(width).

The anode catalyst layer 16 preferably has a plurality of through-pores 40 that extend from one surface in contact with the electrolyte membrane 10 to the other surface in contact with the anode diffusion layer 17. The through-pore 40 has a portion where the pore diameter is smallest (throat portion) 40a. FIG. 2 is a schematic longitudinal cross-sectional view showing the anode catalyst layer 16 having the through-pores 40 and the throat portions 40a present therein.

The anode catalyst layer can be formed by using, for example, an anode catalyst ink containing solids (the first particulate conductive carbon, the anode catalyst supported thereon, the first polymer electrolyte, etc.), and a predetermined dispersion medium. The anode catalyst ink is applied onto one principal surface of the electrolyte membrane 10 and dried. Upon drying, the solids agglomerate, to form agglomerated regions 40b. In the agglomerated regions 40b, the first conductive carbon particles supporting the anode catalyst particles are bonded to each other via the first polymer electrolyte.

There are voids between the agglomerated regions 40b, and these voids continuously communicate with each other through the anode catalyst layer 16 from one surface facing the electrolyte membrane 10 to the other surface facing the anode diffusion layer 17, forming the through-pores 40. The larger the sizes of the agglomerated regions 40b are, the larger the sizes of the voids between the agglomerated regions 40b are.

The diameters of the throat portions 40a have a great influence on the diffusibility of a liquid fuel such as methanol and the ability to discharge carbon dioxide being a reaction product. The distribution of the diameters of the throat portions can be determined from a pore throat size distribution as measured by a half-dry/bubble-point method (ASTM E1294-89 and F316-86) using an automated pore size distribution measurement system for porous materials (hereinafter referred to as a “perm parameter”). The “pore throat size” as used herein refers to the diameter of a circle having the same area as the smallest cross section of the through-pore (the cross section of the throat portion).

The anode catalyst layer 16 preferably has a pore throat size distribution in which the cumulative ratio of pore throat sizes of 0.5 μm or less is 10 to 20%.

In the anode catalyst layer having such a structure, the ability to discharge carbon dioxide is unlikely to degrade, and the liquid fuel can be uniformly dispersed through the minute void region present in the anode catalyst layer. As such, even in the case of using a smaller amount of anode catalyst, the three-phase interfaces serving as the electrode reaction sites can be sufficiently ensured. Consequently, the anode overvoltage can be maintained low.

When the cumulative ratio of pore throat sizes of 0.5 μm or less is less than 10%, it becomes difficult to allow the liquid fuel to be uniformly dispersed through the minute void region present in the anode catalyst layer. Therefore, in the case of using a smaller amount of anode catalyst, the power generation characteristics may somewhat deteriorate. When the cumulative ratio is more than 20%, the ability to discharge carbon dioxide may degrade.

In the pore throat size distribution, the largest pore diameter of the through-pores of the anode catalyst layer is preferably 2 to 3 μm, and the mean flow pore diameter thereof is preferably 0.8 to 1.2 μm.

Carbon dioxide being an anode reaction product is considered to selectively permeate through through-pores having the largest pore diameter or a diameter close thereto, showing a behavior of viscous flow. On the other hand, a liquid fuel such as methanol is considered to permeate through the other through-pores except the above, showing a behavior of diffusion flow. The largest pore diameter relates to the ability to discharge carbon dioxide. The mean flow pore diameter relates to the diffusibility of liquid fuel, as well as to the formation of three-phase interfaces due to the supply of liquid fuel to the anode catalyst layer.

When the largest pore diameter in the anode catalyst layer is less than 2 μm, the ability to discharge carbon dioxide may degrade. On the other hand, when the largest pore diameter is more than 3 μm, the ability to discharge carbon dioxide improves, but the fuel crossover becomes more likely to occur, and the fuel utilization may be lowered. Moreover, the cathode electrode potential is decreased, and the power generation performance may be deteriorated.

When the mean flow pore diameter in the anode catalyst layer is less than 0.8 μm, it may become difficult to uniformly supply fuel to the anode catalyst layer. On the other hand, when the mean flow pore diameter is more than 1.2 μm, in the case of using an aqueous solution containing fuel at a high concentration, the amount of fuel crossover may increase, which may reduce the surface uniformity in the power generation region.

The anode catalyst layer 16 preferably has an air permeability of 0.05 to 0.08 L/(min·cm²·kPa). The anode catalyst layer having such an air permeability includes a large number of passages through which carbon dioxide can be selectively discharged. Therefore, the anode catalyst layer 16 can have a further improved liquid fuel diffusibility.

The largest pore diameter, mean flow pore diameter, and cumulative ratio of pore throat sizes of 0.5 μm or less in a pore throat size distribution of the through-pores, and air permeability of the anode catalyst layer can be measured with a perm porometer.

The sample used for measurement is prepared by forming an anode catalyst layer on a polytetrafluoroethylene (PTFE) porous membrane, and punching the catalyst-carrying membrane into a predetermined size. For evaluation of the physical properties of the anode catalyst layer itself, the PTFE porous membrane is required to have an air permeability which is one order of magnitude higher than that of the anode catalyst layer and not to allow the anode catalyst ink to intrude thereinto, because such PTFE porous membrane will not influence the physical property evaluation of the anode catalyst layer itself.

(Largest Pore Diameter)

The measurement sample is immersed in Silwick reagent whose surface tension γ is low for 60 minutes in a reduced pressure environment, so that the through-pores of the measurement sample are filled with Silwick reagent.

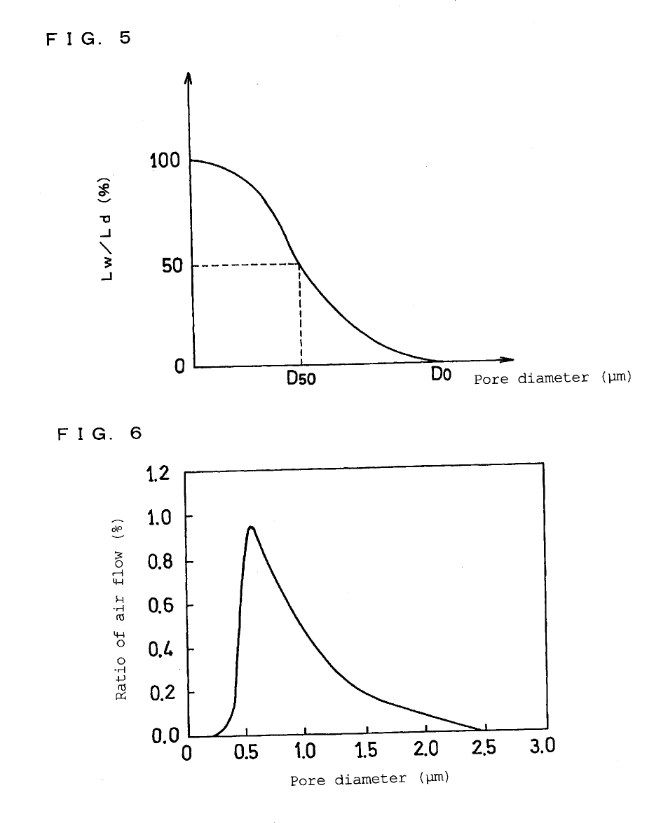

Next, the measurement sample impregnated with Silwick reagent is mounted on a perm porometer. Air is supplied to the measurement sample, and the air pressure is increased continuously. At this time, a pressure (bubble point pressure) P_{ø} as shown in FIG. 4 at the moment when the air flow through the measurement sample starts increasing from zero is measured. Using the measured P_{ø}, the largest pore diameter D_{ø} of the through-pores of the anode diffusion layer can be calculated from the following formula (1):

D_{ø}=(C×γ)/P_{ø} (1)

In the formula (1), γ represents the surface tension of the Silwick reagent (20.1 mN/m), and C represents the specific constant of proportionality (2.86).

(Mean Flow Pore Diameter)

In the same manner as measurement of the largest pore diameter, the through-pores of the measurement sample are filled with Silwick reagent.

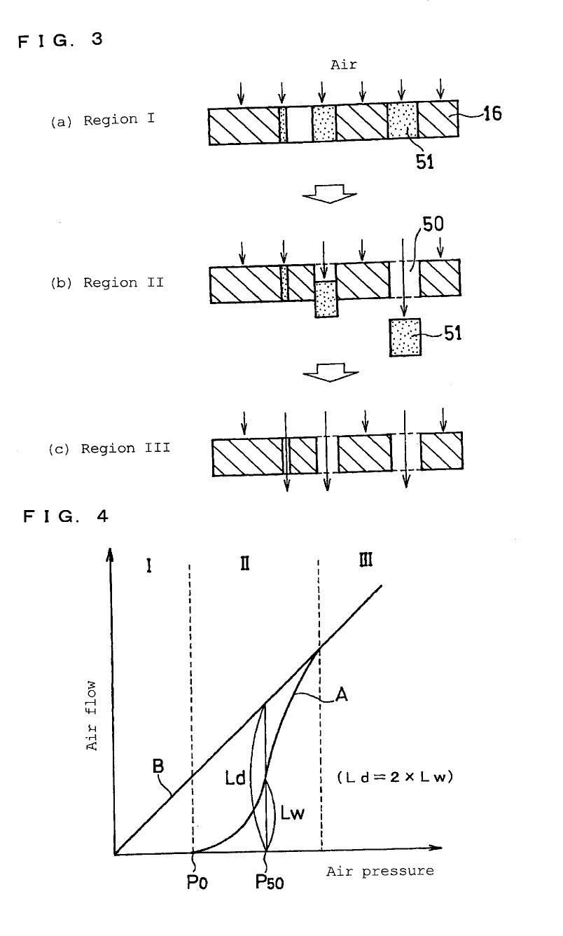

Next, air is supplied in the same manner as measurement of the largest pore diameter. As illustrated in FIG. 3(a), Silwick reagent 51 is not pushed out of through-pores 50 before the air pressure reaches P_{ø} (Region I). As illustrated in FIG. 3(b), when the air pressure reaches P_{ø} or more, the Silwick reagent 51 is pushed out of the through-pores 50, and an air flow Lw therethrough increases. At this time, the Silwick reagent is pushed out sequentially from the through-pores in decreasing order of the pore diameter (Region II). As illustrated in FIG. 3(c), as the air pressure is further increased, the Silwick reagent 51 is pushed out of all the through-pores 50 (Region III). A wet flow curve A shown in FIG. 4 is thus obtained. In this measurement, the air pressure is increased until the air flow reaches 200 L/min.

The same measurement sample is used as it is to measure an air flow Ld in the case where the air pressure is increased continuously. In this measurement also, the air pressure is increased until the air flow reaches 200 L/min. A dry flow curve B shown in FIG. 4 is thus obtained.

With respect to the wet flow curve A shown in FIG. 4, the air pressure P is converted to a pore diameter D from the following formula (2):

D=(C×γ)/P (2).

Plotting Lw/Ld against the pore diameter D yields a graph as shown in FIG. 5. Lw/Ld is an integrated value of the ratio of the wet flow to the dry flow at a given pore diameter D. In the graph shown in FIG. 5, the pore size giving a Lw/Ld of 50% is a mean flow pore diameter D₅₀ in a pore throat size distribution. The pore size giving a Lw/Ld of 0% is a largest pore diameter D_{ø} in a pore throat size distribution. The mean flow pore diameter D₅₀ determined in this manner means a through-pore diameter at the point of time when the air flow passing through the through-pores of the anode catalyst layer reaches 50% of the total air flow. Conversion of the graph of FIG. 5 representing the integrated values into a graph representing the degree of contribution at each pore diameter can yield, for example, a graph as shown in FIG. 6.

(Cumulative Ratio of Pore Throat Sizes of 0.5 μm or Less)

From the graph of FIG. 5 showing the relationship between pore diameter D and Lw/Ld being an integrated value of the ratio of wet flow to dry flow, an integrated value Lw/Ld giving a pore diameter D of 0.5 μm is determined. Subtracting the determined integrated value from the total integrated value 100% yields a cumulative ratio of pore throat sizes of 0.5 μm or less.

(Air Permeability)

The air permeability of the anode catalyst layer 16 can be determined from the slope of the dry flow curve B (the slope of air flow Ld vs. air pressure) shown in FIG. 4.

In both cases where liquid passes through the through-pores and gas passes through the through-pores, the flow thereof is affected by the narrowest portions of the through-pores. Accordingly, the largest pore diameter, mean flow pore diameter, cumulative ratio of pore throat sizes of 0.5 μm or less, and air permeability determined by the abovementioned measurement method reflect the diameters of the throat portions of the through-pores.

The anode catalyst layer 16 preferably has a proton conductive resistance of 0.05 to 0.25Ω·cm². This can sufficiently ensure the three-phase interfaces in the anode catalyst layer 16, even in the case of using a smaller amount of anode catalyst. As a result, the anode overvoltage can be maintained at a lower level.

The thickness of the anode catalyst layer 16 is preferably 20 to 100 μm, and more preferably 40 to 80 μm. When the thickness of the anode catalyst layer 16 is less than 20 μm, the porosity may not be sufficiently ensured. On the other hand, when the thickness is more than 100 μm, the proton conductivity and electron conductivity of the anode catalyst layer may not be maintained.

The thickness of the anode catalyst layer 16 is determined by, for example, observing a longitudinal cross section of the anode catalyst layer 16 under an electron microscope. Specifically, the thickness of the anode catalyst layer 16 is measured under an electron microscope at, for example, given 10 points. The average of the measured values can be regarded as the thickness of the anode catalyst layer 16.

The porosity of the anode catalyst layer 16 is preferably 70 to 85%. Setting the porosity of the anode catalyst layer 16 from 70 to 85% makes it possible to ensure that both the region having passages effective for diffusing fuel and discharging carbon dioxide and the region contributing to electron conduction and proton conduction are present within the anode catalyst layer 16. As a result, the anode overvoltage can be maintained at a lower level.

The porosity of the anode catalyst layer 16 can be determined by, for example, photographing a cross section of the anode catalyst layer 16 at given 10 points under a scanning electron microscope (SEM), and image-processing (thresholding) the obtained image data.

The cathode catalyst layer, like the anode catalyst layer as described above, preferably has a plurality of through-pores. The through-pores have a portion where the pore diameter is smallest (throat portion).

The cathode catalyst layer can be formed by using, for example, a cathode catalyst ink including solids (the second particulate conductive carbon, the cathode catalyst supported thereon, the second polymer electrolyte, etc.), and a predetermined dispersion medium. The cathode catalyst ink is applied onto the other principal surface of the electrolyte membrane 10 and dried. Upon drying, the solids agglomerate, to form agglomerated regions. In the agglomerated regions, the second conductive carbon particles supporting the cathode catalyst particles are bonded to each other via the second polymer electrolyte. Between the agglomerated regions, there are voids like those in the anode catalyst layer. These voids continuously communicate with each other through the cathode catalyst layer from one surface facing the electrolyte membrane to the other surface facing the cathode diffusion layer, forming the through-pores.

The diameters of the throat portions of the cathode catalyst layer have a great influence on the diffusibility of oxidant and the ability to discharge water. The distribution of the diameters of the throat portions of the cathode catalyst layer can be measured using a cathode catalyst layer as the measurement sample, by the same method as for the anode catalyst layer.

The cathode catalyst layer preferably has a pore throat size distribution in which the cumulative ratio of pore throat sizes of 0.5 μm or less is 2 to 10%. In the cathode catalyst layer having such a structure, the diffusibility of oxidant and the ability to discharge water are unlikely to degrade.

In the pore throat size distribution, the largest pore diameter of the through-pores of the cathode catalyst layer is preferably 2 to 3 μm, and the mean flow pore diameter thereof is preferably 0.8 to 1.2 μm.

Liquid water accumulated at the cathode is considered to selectively permeate through through-pores having the largest pore diameter or a diameter close thereto, showing a behavior of viscous flow. On the other hand, an oxidant is considered to permeate through the other through-pores except the above, showing a behavior of diffusion flow. The largest pore diameter relates to the ability to discharge water. The mean flow pore diameter relates to the diffusibility of oxidant, as well as to the formation of three-phase interfaces due to the supply of oxidant to the cathode catalyst layer.

When the largest pore diameter in the cathode catalyst layer is less than 2 μm, the ability to discharge water may deteriorate. On the other hand, when the largest pore diameter is more than 3 μm, the volume of the through-pores in the catalyst layer increases excessively, and liquid water is likely to accumulate at the interface between the cathode catalyst layer and the electrolyte membrane. This may result in a slower diffusion of oxidant.

When the mean flow pore diameter in the cathode catalyst layer is less than 0.8 μm, the diffusion of oxidant may be slowed. On the other hand, when the mean flow pore diameter is more than 1.2 μm, the oxidant may not be uniformly supplied, which may reduce the surface uniformity in the power generation region.

The cathode catalyst layer 18 preferably has an air permeability of 0.02 to 0.05 L/(min·cm²·kPa). The cathode catalyst layer having such an air permeability is excellent in oxidant diffusibility. Moreover, even when the second polymer electrolyte has swelled, the power generation performance of the fuel cell is unlikely to deteriorate.

The largest pore diameter, mean flow pore diameter, and cumulative ratio of pore throat sizes of 0.5 μm or less in a pore throat size distribution of the through-pores, and air permeability of the cathode catalyst layer can be measured with a perm porometer, like those of the anode catalyst layer. The sample used for measurement may be prepared by forming a cathode catalyst layer on a PTFE porous membrane, and punching the catalyst-carrying membrane into a predetermined size.

The cathode catalyst layer preferably has a proton conductive resistance of 0.5 to 1Ω·cm². This allows the electrode reaction on the cathode side to proceed smoothly, while suppressing the decrease of voids due to the swelling of the second polymer electrolyte.

The thickness of the cathode catalyst layer 18 is preferably 30 to 80 μm, and more preferably 40 to 60 μm. When the thickness of the cathode catalyst layer 18 is less than 30 μm, the porosity may not be ensured sufficiently. On the other hand, when the thickness is more than 80 μm, the proton conductivity and electron conductivity of the cathode catalyst layer may not be maintained. The thickness of the cathode catalyst layer 18 may be determined by, for example, the same method as for the anode catalyst layer 16.

The porosity of the cathode catalyst layer 18 is preferably 65 to 85%. Setting the porosity of the cathode catalyst layer 18 from 65 to 85% makes it possible to ensure that both the region having passages effective for diffusing oxidant and discharging water and the region contributing to electron conduction and proton conduction are present within the cathode catalyst layer 18. As a result, the cathode overvoltage can be maintained at a lower level. The porosity of the cathode catalyst layer 18 may be determined by, for example, the same method as for the anode catalyst layer 16.

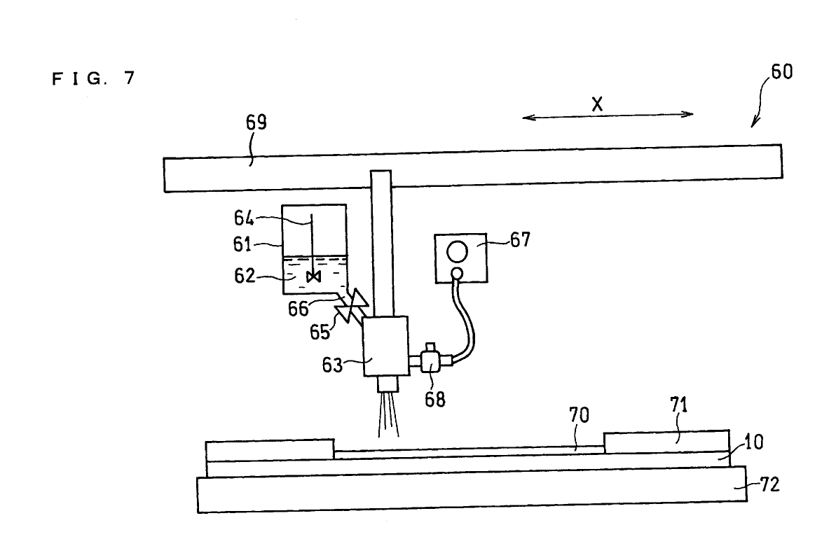

Next, the method of forming the anode catalyst layer 16 and the cathode catalyst layer 18 is described with reference to FIG. 7. FIG. 7 is a schematic illustration of an exemplary configuration of a spray coater used for forming the anode catalyst layer 16 and the cathode catalyst layer 18.

A spray coater 60 has a tank 61 containing a catalyst ink 62, and a spray gun 63.

In the tank 61, the catalyst ink 62 is being stirred with a stirrer 64 and is in a constant fluid state. The catalyst ink 62 is fed to the spray gun 63 through a supply pipe 66 equipped with an open/close valve 65, and is ejected together with a jet gas from the spray gun 63. The jet gas is supplied to the spray gun 63 through a gas pressure regulator 67 and a gas flow regulator 68. The jet gas that can be used here is, for example, nitrogen gas.

In the spray coater 60 of FIG. 7, the spray gun 63 is coupled with an actuator 69 and is movable from any position at any speed in two directions: the X axis parallel to the arrow X; and the Y axis perpendicular to the X axis and to the drawing sheet.

The electrolyte membrane 10 is located below the spray gun 63. The spray gun 63 is moved while the catalyst ink 62 is being ejected. A catalyst layer is thus formed on the electrolyte membrane 10. A coating area 70 coated with the catalyst ink 62 on the electrolyte membrane 10 can be adjusted using a mask 71. In forming a catalyst layer, the surface temperature of the electrolyte membrane 10 is preferably adjusted using a heater 72.

The pore throat size distribution of the through-pores and air permeability of the catalyst layer can be controlled by adjusting the moving speed of the spray gun 63, the ejecting amount of the catalyst ink 62, and the surface temperature of the electrolyte membrane 10. The ejecting amount of the catalyst ink 62 can be adjusted by regulating the pressure and flow rate of the gas for ink ejection. Specifically, for example, the pore diameter of the through-pores and air permeability of each catalyst layer can be increased by increasing the moving speed of the spray gun 63, decreasing the ejecting amount of the corresponding catalyst ink, and increasing the surface temperature of the electrolyte membrane 10.

Alternatively, the air permeability of each catalyst layer can be controlled by adjusting the conditions for ultrasonic dispersion processing (processing power, processing time, etc.) in preparing the catalyst ink.

The anode catalyst layer 16 and the cathode catalyst layer 18 can be alternatively formed by screen printing, die coating, or other methods. In this case, the pore throat size distribution of the through-pores and air permeability of each catalyst layer can be controlled by, for example, adjusting the composition and/or solid concentration of the catalyst ink, or optimizing the conditions for drying.

In the present invention, no limitation is imposed on the components other than the anode and cathode catalyst layers 16 and 18. Description is given below of the components other than the anode and cathode catalyst layers 16 and 18, with reference to FIG. 1.

The electrolyte membrane 10 is preferably excellent in proton conductivity, heat resistance, chemical stability, and resistance to swelling with methanol. The material (polymer electrolyte) constituting the electrolyte membrane 10 is not particularly limited and may be any material that imparts the above characteristics to the electrolyte membrane 10. Examples thereof include PTFE.

The anode and cathode diffusion layers 17 and 19 each have an electrically conductive porous substrate and a porous composite layer disposed on a surface of the conductive porous substrate. The porous composite layer includes electrically conductive carbon particles and a water-repellent binder material. The amount of the porous composite layer on the surface of the conductive porous substrate is preferably 1 to 3 mg/cm². The amount of the porous composite layer is an amount per projected unit area cm² of the porous composite layer.

The conductive porous substrate used for the anode diffusion layer 17 is preferably an electrically conductive porous material with fuel diffusibility, ability to discharge carbon dioxide produced by power generation, and electron conductivity. Examples of such a material include carbon paper, carbon cloth, and carbon non-woven fabric.

Furthermore, a water-repellent binder material may be allowed to adhere to the conductive porous substrate. In other words, the conductive porous substrate may be subjected to water-repellent treatment. Examples of the water-repellent binder material include fluorocarbon resins such as polytetrafluoroethylene resin (PTFE), tetrafluoroethylene-hexafluoropropylene copolymer (FEP), polyvinyl fluoride resin (PVF), polyvinylidene fluoride resin (PVDF), and tetrafluoroethylene-perfluoro(alkyl vinyl ether) copolymer (PFA).

The conductive porous substrate used for the cathode diffusion layer 19 is preferably an electrically conductive porous material with oxidant diffusibility, ability to discharge water produced by power generation and water moved from the anode side, and electron conductivity. Examples of such a material include carbon paper, carbon cloth, and carbon non-woven fabric.

Furthermore, a water-repellent binder material may be allowed to adhere to the conductive porous substrate. In other words, the conductive porous substrate may be subjected to water-repellent treatment. Examples of the water-repellent binder material are the same as those listed for the anode diffusion layer 17.

The aforementioned fluorocarbon resins may be used as the water-repellent binder material included in the porous composite layers of the anode and cathode diffusion layers 17 and 19.

The conductive carbon particles included in the porous composite layer are preferably mainly composed of electrically conductive carbon black. The conductive carbon black preferably has a highly developed structure, and has a specific surface area of about 200 to 300 m²/g.

The “projected unit area of each porous composite layer” is an area calculated using the contour of the porous composite layer as viewed in the direction normal to the principal surface of the porous composite layer. For example, when the contour of the porous composite layer as viewed in the normal direction is rectangular, the projected unit area can be calculated from (length)×(width).

It suffices if the separators 14 and 15 have hermeticity, electron conductivity, and electrochemical stability, and the materials thereof are not particularly limited. The shapes of the flow channels 20 and 21 also are not particularly limited.

The current collector plates 24 and 25, the sheet heaters 26 and 27, the insulator plates 28 and 29, and the end plates 30 and 31 may be made of any material known in the art.

### EXAMPLES

The present invention is specifically described below by way of Examples, but these Examples are not to be construed as limiting the present invention.

### Example 1

A direct oxidation fuel cell as illustrated in FIGS. 1 and 2 was produced.

<Preparation of Anode Catalyst Layer>

A first particulate conductive carbon supporting Pt—Ru fine particles having a mean particle size of 2 nm (Pt:Ru weight ratio=3:2) was used as an anode catalyst. The first particulate conductive carbon used here was carbon black (Ketjen black EC available from Mitsubishi Chemical Corporation) in which the average particle diameter of primary particles was 30 nm. The weight ratio of the Pt—Ru fine particles to the total of the Pt—Ru fine particles and the first particulate conductive carbon was set to 70 wt %.

The anode catalyst was ultrasonically dispersed in an aqueous isopropanol solution (concentration of isopropanol: 50 wt %) serving as a dispersion medium for 60 minutes. To the resultant dispersion, a predetermined amount of 5 wt % solution of a first polymer electrolyte (perfluorocarbon sulfonic acid polymer) (an aqueous solution of 5% Nafion available from Sigma-Aldrich Co. LLC.) whose ion exchange capacity IEC₁ was in the range of 0.95 to 1.03 was added, and stirred with a disper, to prepare an anode catalyst ink. In the anode catalyst ink, the weight ratio of the first polymer electrolyte to the total solids was set to 28 wt %. This value corresponds to a weight ratio M₁ of the first polymer electrolyte in the anode catalyst layer, in a fuel cell.

Next, the tank 71 of a coater as illustrated in FIG. 7 was filled with the anode catalyst ink. The anode catalyst ink was applied 30 times in total onto one principal surface of an electrolyte membrane 10 in its thickness direction, to form an anode catalyst layer 16. The electrolyte membrane 10 used here was an electrolyte membrane (Nafion 112 available from E.I. du Pont de Nemours and Company) cut in a size of 10 cm×10 cm. The anode catalyst layer 16 was formed in the size of 6 cm×6 cm. The moving speed of the spray gun 73 for application of the anode catalyst ink was set to 60 mm/sec, and the jetting pressure of the jet gas (nitrogen gas) was set to 0.15 MPa. The surface temperature of the electrolyte membrane 10 was adjusted to 65° C. The amount of anode catalyst (Pt—Ru fine particles) in the anode catalyst layer 16 was 3.45 mg/cm².

<Preparation of Cathode Catalyst Layer>

A second particulate conductive carbon supporting Pt fine particles having a mean particle size of 2 nm was used as a cathode catalyst. The second particulate conductive carbon used here was carbon black (Ketjen black EC available from Mitsubishi Chemical Corporation) in which the average particle diameter of primary particles was 30 nm. The weight ratio of the Pt fine particles to the total of the Pt fine particles and the second particulate conductive carbon was set to 46 wt %.

The cathode catalyst was ultrasonically dispersed in an aqueous isopropanol solution (concentration of isopropanol: 50 wt %) serving as a dispersion medium for 60 minutes. To the resultant dispersion, a predetermined amount of 5 wt % solution of a second polymer electrolyte (perfluorocarbon sulfonic acid polymer) (an aqueous solution of 5% Nafion available from Sigma-Aldrich Co. LLC.) whose ion exchange capacity IEC₂ was in the range of 0.95 to 1.03 was added, and stirred with a disper, to prepare a cathode catalyst ink. In the cathode catalyst ink, the weight ratio of the second polymer electrolyte to the total solids was set to 19 wt %. This value corresponds to a weight ratio M₂ of the second polymer electrolyte in the cathode catalyst layer, in a fuel cell.

The tank 71 of the coater as illustrated in FIG. 7 was filled with the cathode catalyst ink. The cathode catalyst ink was applied 40 times in total onto the other principal surface of the electrolyte membrane 10 in its thickness direction, so that a cathode catalyst layer 18 was formed so as to be opposed to the anode catalyst layer 16. The cathode catalyst layer 18 was formed in the size of 6 cm×6 cm. The moving speed of the spray gun 73 for application of the cathode catalyst ink was set to 60 mm/sec, and the jetting pressure of the jet gas (nitrogen gas) was set to 0.15 MPa. The surface temperature of the electrolyte membrane 10 was adjusted to 65° C. The amount of cathode catalyst (Pt fine particles) in the cathode catalyst layer 18 was 1.25 mg/cm².

A catalyst coated membrane (CCM) was thus obtained.

<Preparation of Anode Diffusion Layer>

An anode diffusion layer 17 was produced by allowing a water-repellent binder material to adhere to a conductive porous substrate, and then forming a porous composite layer on a surface of the conductive porous substrate. The conductive porous substrate used here was carbon paper (TGP-H090 available from Toray Industries Inc.).

First, the conductive porous substrate was subjected to water-repellent treatment. Specifically, the conductive porous substrate was immersed in a polytetrafluoroethylene resin (PTFE) dispersion with solid concentration of 7 wt % (an aqueous solution prepared by diluting D-1E available from Daikin Industries, Ltd. with ion-exchange water) for 1 minute. The conductive porous substrate after immersion was dried at room temperature in the air for 3 hours. Thereafter, the conductive porous substrate after drying was heated at 360° C. in an inert gas (N₂) for 1 hour to remove the surfactant. In this manner, water-repellent treatment was applied to the conductive porous substrate. The content of PTFE in the conductive porous substrate after water-repellent treatment was 12.5 wt %.

Thereafter, a porous composite layer was formed on a surface of the conductive porous substrate after water-repellent treatment in the following manner.

First, carbon black (VulcanXC-72R available from CABOT Corporation) being a conductive carbon material was added to an aqueous solution containing a surfactant (Triton X-100 available from Sigma-Aldrich Co. LLC.), and highly dispersed therein with a kneader-disperser (HIVIS MIX available from PRIMIX Corporation). To the resultant dispersion, a PTFE dispersion (D-1E available from Daikin Industries, Ltd.) being a water-repellent resin material was added and stirred for 3 hours with a disper, to prepare a paste for forming a porous composite layer. This paste for forming a porous composite layer was uniformly applied onto one surface of the conductive porous substrate with a doctor blade coater, and dried at room temperature in the air for 8 hours. The conductive porous substrate was then baked at 360° C. in an inert gas (N₂) for 1 hour to remove the surfactant, so that a porous composite layer was formed. The PTFE content in the porous composite layer was 40 wt %, and the amount of the porous composite layer per projected unit area was 2.4 mg/cm².

<Preparation of Cathode Diffusion Layer>

A cathode diffusion layer 19 was produced by allowing a water-repellent binder material to adhere to a conductive porous substrate, and then forming a porous composite layer on a surface of the conductive porous substrate. The conductive porous substrate used here was carbon paper (TGP-H090 available from Toray Industries Inc.).

First, the conductive porous substrate was subjected to water-repellent treatment. Specifically, the conductive porous substrate was immersed in a polytetrafluoroethylene resin (PTFE) dispersion with solid concentration of 15 wt % (an aqueous solution prepared by diluting 60% PTFE dispersion available from Sigma-Aldrich Co. LLC. with ion-exchange water) for 1 minute. The conductive porous substrate after immersion was dried at room temperature in the air for 3 hours. Thereafter, the carbon paper after drying was heated at 360° C. in an inert gas (N₂) for 1 hour to remove the surfactant. In this manner, water-repellent treatment was applied to the conductive porous substrate. The content of PTFE in the conductive porous substrate after water-repellent treatment was 23.5 wt %.

Subsequently, a conductive porous substrate was formed on a surface of the conductive porous substrate after water-repellent treatment in the same manner as for the anode diffusion layer 17. At this time, by changing the setting gap of the doctor blade when applying the paste for forming a porous composite layer on one surface of the conductive porous substrate, the applied amount of the porous composite layer was adjusted. The PTFE content in the porous composite layer was 40 wt %, and the amount of the porous composite layer per projected unit area was 1.8 mg/cm².

<Production of MEA>

The anode diffusion layer 17 and the cathode diffusion layer 19 were each cut in the size of 6 cm×6 cm, and they were disposed on both sides of the catalyst coated membrane (CCM) such that the porous composite layers of the anode and cathode diffusion layers were in contact with the anode and cathode catalyst layers, respectively. Subsequently, they were hot-pressed (at 130° C. and 4 MPa for 3 min) to bond the catalyst layers to the diffusion layers. In this manner, a membrane electrode assembly (MEA) was produced.

<Production of Fuel Cell>

An anode-side gasket 22 and a cathode-side gasket 23 were disposed around the anode 11 and cathode 12 of the MEA 13 so as to sandwich the electrolyte membrane 10. The anode-side and cathode-side gaskets 22 and 23 used here were three-layer structures each including a polyetherimide intermediate layer, and silicone rubber layers disposed on both sides thereof.

The MEA 13 fitted with the gaskets were sandwiched between anode-side and cathode-side separators 14 and 15, current collector plates 24 and 25, sheet heaters 26 and 27, insulator plates 28 and 29, and end plates 30 and 31, each of which had outer dimensions of 12 cm×12 cm, and they were secured by clamping rods. The clamping pressure was set to 12 kgf/cm² per unit area of the separators.

The anode-side and cathode-side separators 14 and 15 were formed of a resin-impregnated graphite material of 4 mm in thickness (G347B available from TOKAI CARBON CO., LTD.). Each of the separators had been provided in advance with a serpentine flow channel having a width of 1.5 mm and a depth of 1 mm. The current collector plates 24 and 25 were gold-plated stainless steel plates. The sheet heaters 26 and 27 were SEMICON heaters (available from SAKAGUCHI E.H. VOC CORP.).

A direct oxidation fuel cell (Cell A) was produced in the manner as described above.

### Example 2

A direct oxidation fuel cell (Cell B) was produced in the same manner as in Example 1, except that the weight ratio of the first polymer electrolyte to the total solids of the anode catalyst ink was set to 26 wt %, and the weight ratio of the second polymer electrolyte to the total solids of the cathode catalyst ink was set to 22 wt %.

### Example 3

A direct oxidation fuel cell (Cell C) was produced in the same manner as in Example 1, except that the weight ratio of the first polymer electrolyte to the total solids of the anode catalyst ink was set to 33 wt %, and the weight ratio of the second polymer electrolyte to the total solids of the cathode catalyst ink was set to 17 wt %.

### Example 4

A direct oxidation fuel cell (Cell D) was produced in the same manner as in Example 1, except that the weight ratio of the first polymer electrolyte to the total solids of the anode catalyst ink was set to 25 wt %.

### Example 5

A direct oxidation fuel cell (Cell E) was produced in the same manner as in Example 1, except that the weight ratio of the first polymer electrolyte to the total solids of the anode catalyst ink was set to 22 wt %.

### Example 6

A direct oxidation fuel cell (Cell F) was produced in the same manner as in Example 1, except that the weight ratio of the first polymer electrolyte to the total solids of the anode catalyst ink was set to 36 wt %, and the weight ratio of the second polymer electrolyte to the total solids of the cathode catalyst ink was set to 16 wt %.

### Example 7

A direct oxidation fuel cell (Cell G) was produced in the same manner as in Example 1, except that the anode catalyst ink was applied 4 times in total, and the amount of anode catalyst (Pt—Ru fine particles) in the anode catalyst layer was set to 0.4 mg/cm².

### Example 8

A direct oxidation fuel cell (Cell H) was produced in the same manner as in Example 1, except that the concentration of isopropanol in the dispersion medium in which the anode catalyst was to be ultrasonically dispersed was set to 30 wt %, and ultrasonic dispersion was performed for 30 minutes.

### Comparative Example 1

A direct oxidation fuel cell (Comparative Cell 1) was produced in the same manner as in Example 1, except that the weight ratio of the first polymer electrolyte to the total solids of the anode catalyst ink was set to 19 wt %, and the weight ratio of the second polymer electrolyte to the total solids of the cathode catalyst ink was set to 28 wt %.

### Comparative Example 2

A direct oxidation fuel cell (Comparative Cell 2) was produced in the same manner as in Example 1, except that the weight ratio of the first polymer electrolyte to the total solids of the anode catalyst ink was set to 19 wt %.

### Comparative Example 3

A direct oxidation fuel cell (Comparative Cell 3) was produced in the same manner as in Example 1, except that the weight ratio of the second polymer electrolyte to the total solids of the cathode catalyst ink was set to 28 wt %.

The configurations of Cells A to H and Comparative Cells 1 to 3 are shown in Table 1.

TABLE 1

| | | | | Amount of | Amount of |
|---|---|---|---|---|---|
| | | | | anode | cathode |
| | M₁ | M₂ | | catalyst | catalyst |
| | (wt %) | (wt %) | M₁ − M₂ | (mg/cm²) | (mg/cm²) |
| Cell A | 28 | 19 | 9 | 3.45 | 1.25 |
| Cell B | 26 | 22 | 4 | 3.45 | 1.25 |
| Cell C | 33 | 17 | 16 | 3.45 | 1.25 |
| Cell D | 25 | 19 | 6 | 3.45 | 1.25 |
| Cell E | 22 | 19 | 3 | 3.45 | 1.25 |
| Cell F | 36 | 16 | 20 | 3.45 | 1.25 |
| Cell G | 28 | 19 | 9 | 0.4 | 1.25 |
| Cell H | 28 | 19 | 9 | 3.45 | 1.25 |
| Comparative | 19 | 28 | −9 | 3.45 | 1.25 |
| Cell 1 | | | | | |
| Comparative | 19 | 19 | 0 | 3.45 | 1.25 |
| Cell 2 | | | | | |
| Comparative | 28 | 28 | 0 | 3.45 | 1.25 |
| Cell 3 | | | | | |

[Evaluation]

With respect to the anode and cathode catalyst layers of Cells A to H and Comparative Cells 1 to 3, the largest pore diameter, mean flow pore diameter, and cumulative ratio of pore throat sizes of 0.5 μm or less in a pore throat size distribution of the through-pores, and air permeability were measured using an automated pore size distribution measurement system for porous materials (perm porometer) available from Porous Materials, Inc. (PMI), in the manner as described below.

The measurement samples used here were prepared by forming an anode or cathode catalyst layer under the same conditions as in each of Examples 1 to 8 and Comparative Examples 1 to 3, on one surface of a PTFE porous film (TEMISH S-NTF1133 available from Nitto Denko Corporation), and punching the catalyst-carrying film into a disk shape of 25 mm in diameter. This PTFE porous film has an air permeability which is one order of magnitude higher than those of the anode and cathode catalyst layers, and does not allow an intrusion of catalyst ink thereinto. Therefore, the physical properties of the catalyst layer itself can be evaluated while the catalyst layer is on the PTFE porous film.

(Largest Pore Diameter)

Each measurement sample was immersed in Silwick reagent whose surface tension γ was 20.1 mN/m for 60 minutes in a reduced pressure environment, so that the through-pores of the measurement sample were filled with Silwick reagent.

Next, the measurement sample impregnated with Silwick reagent was mounted on the perm porometer. The air pressure was increased continuously, to measure a pressure (bubble point pressure) P_{ø} at the moment when the air flow started increasing from zero. Using the measured P_{ø}, the largest pore diameter D_{ø} of the through-pores was calculated from the following formula (1):

D_{ø}=(C×γ)/P_{ø} (1)

(Mean Flow Pore Diameter)

In the same manner as measurement of the largest pore diameter, the through-pores of the measurement sample were filled with Silwick reagent. Thereafter, the measurement sample was mounted on the perm porometer, and the air pressure was increased continuously until the air flow reached 200 L/min. A wet flow curve was thus obtained.

The same measurement sample was used as it was to measure an air flow through the sample in the case where the air pressure was increased continuously. In this measurement also, the air pressure was increased continuously until the air flow reaches 200 L/min. A dry flow curve was thus obtained.

Thereafter, P₅₀ at which the air flow Lw on the wet flow curve reached 50% of the air flow Ld on the dry flow curve was determined. Using the determined P₅₀, a mean flow pore diameter D₅₀ of through-pores was calculated from the following formula (2):

D₅₀=(C×γ)/P₅₀ (2)

(Cumulative Ratio of Pore Throat Sizes of 0.5 μm or Less)

From the graph showing the relationship between pore diameter D and Lw/Ld being an integrated value of the ratio of wet flow to dry flow, an integrated value Lw/Ld giving a pore diameter D of 0.5 μm was determined. Subtracting the integrated value from the total integrated value 100% yielded a cumulative ratio of pore throat sizes of 0.5 μm or less.

(Air Permeability)

An air permeability was determined from the slope of the dry flow curve (the slope of air flow Ld vs. air pressure).

The largest pore diameter, mean flow pore diameter, and cumulative ratio of pore throat sizes of 0.5 μm or less in a pore throat size distribution of the through-pores, and air permeability of the anode catalyst layer in each Example and Comparative Example are shown in Table 2. The values of them in each cathode catalyst layer are shown in Table 3.

TABLE 2

| | Largest | Mean flow | Cumulative ratio | Air |
|---|---|---|---|---|
| | pore | pore | of pore throat | permeability |
| | diameter | diameter | sizes of 0.5 μm | (L/ |
| | (μm) | (μm) | or less (%) | (min · cm²kPa) |
| Cell A | 2.3 | 1 | 17.4 | 0.063 |
| Cell B | 2.4 | 1.1 | 15.6 | 0.062 |
| Cell C | 2.3 | 1 | 18.7 | 0.067 |
| Cell D | 2.5 | 1.1 | 13.3 | 0.062 |
| Cell E | 3.1 | 1.2 | 9.8 | 0.081 |
| Cell F | 2.3 | 1 | 20.3 | 0.068 |
| Cell G | 1.9 | 1 | 17.1 | 0.048 |
| Cell H | 2.8 | 1.3 | 16.2 | 0.082 |
| Comparative | 3.1 | 1.4 | 9.4 | 0.084 |
| Cell 1 | | | | |
| Comparative | 3.1 | 1.4 | 9.4 | 0.084 |
| Cell 2 | | | | |
| Comparative | 2.3 | 1 | 17.4 | 0.063 |
| Cell 3 | | | | |

TABLE 3

| | Largest | Mean flow | Cumulative ratio | Air |
|---|---|---|---|---|
| | pore | pore | of pore throat | permeability |
| | diameter | diameter | sizes of 0.5 μm | (L/ |
| | (μm) | (μm) | or less (%) | (min · cm²kPa) |
| Cell A | 2.2 | 1 | 4.5 | 0.037 |
| Cell B | 2.1 | 0.9 | 6.3 | 0.032 |
| Cell C | 2.4 | 1.1 | 3.4 | 0.043 |
| Cell D | 2.2 | 1 | 4.5 | 0.037 |
| Cell E | 2.2 | 1 | 4.5 | 0.037 |
| Cell F | 2.6 | 1.2 | 2.7 | 0.048 |
| Cell G | 2.2 | 1 | 4.5 | 0.037 |
| Cell H | 2.2 | 1 | 4.5 | 0.037 |
| Comparative | 1.9 | 0.8 | 10.6 | 0.019 |
| Cell 1 | | | | |
| Comparative | 2.2 | 1 | 4.5 | 0.037 |
| Cell 2 | | | | |
| Comparative | 1.9 | 0.8 | 10.6 | 0.019 |
| Cell 3 | | | | |

With respect to Cells A to H and Comparative Cells 1 to 3, the proton conductive resistance, durability, and Ru deposition amount at the cathode after durability evaluation of the anode and cathode catalyst layers were evaluated. The evaluation methods are shown below.

(1) Proton Conductive Resistance of Anode Catalyst Layer

Journal of Electroanalytical Chemistry 567 (2004) 305-315 was referred to as the method for measuring the proton conductive resistance of the anode catalyst layer.

Humidified nitrogen gas was allowed to flow on the anode side at a flow rate of 0.16 L/min, and humidified hydrogen gas was allowed to flow on the cathode side at a flow rate of 0.16 L/min. In this state, the potential was scanned between 0.07 to 0.45 V at a scan rate of 5 mV/sec by cyclic voltammetry (CV), to yield a current-potential curve. Dividing the current value at a potential of 0.25 V by the area of the anode catalyst layer (36 cm²) and the scan rate gave a double layer capacitance C_{pdl} at the interface between the anode catalyst (Pt—Ru fine particles) and the first polymer electrolyte. Thereafter, while the above humidified gases were allowed to flow, a direct current potential of 0.25 V was applied with an alternating current potential of 1 mV superimposed thereon, and the frequency of alternating current was varied gradually from 10 kHz to 0.1 Hz, to determine a complex impedance |Z| of each cell. The values of |Z| at the frequency ranging from 2 Hz to 60 Hz were plotted against the −½ power of the angular velocity ω. The slope K of the resultant linear plots was determined, and the proton conductive resistance Rₚ of the anode catalyst layer was determined from the formula (3):

RP=K²×C_{Pdl} (3).

The results are shown in Table 4.

(2) Proton Conductive Resistance of Cathode Catalyst Layer

Journal of Electroanalytical Chemistry 567 (2004) 305-315 was referred to as the method for measuring the proton conductive resistance of the cathode catalyst layer, as in the above (1).

Humidified nitrogen gas was allowed to flow on the cathode side at a flow rate of 0.16 L/min, and humidified hydrogen gas was allowed to flow on the anode side at a flow rate of 0.16 L/min. In this state, the potential was scanned between 0.07 to 0.85 V at a scan rate of 5 mV/sec by cyclic voltammetry (CV), to yield a current-potential curve. Dividing the current value at a potential of 0.4 V by the area of the cathode catalyst layer (36 cm²) and the scan rate gave a double layer capacitance C_{pdl} at the interface between the cathode catalyst (Pt fine particles) and the second polymer electrolyte. Thereafter, an alternating current impedance method was used to determine a complex impedance |Z| of each cell. Specifically, while the above humidified gases were allowed to flow, a direct current potential of 0.4 V was applied with an alternating current potential of 1 mV superimposed thereon, and the frequency of alternating current was varied gradually from 10 kHz to 0.1 Hz. The values of |Z| at the frequency ranging from 2 Hz to 60 Hz were plotted against the −½ power of the angular velocity ω. The slope K of the resultant linear plots was determined, and the proton conductive resistance Rₚ of the cathode catalyst layer was determined from the formula (4):

RP=K²×C_{Pdl} (4).

The results are shown in Table 4.

TABLE 4

| | Proton conductive | Proton conductive |
|---|---|---|
| | resistance of anode | resistance of cathode |
| | catalyst layer | catalyst layer |
| | (Ω · cm²) | (Ω · cm²) |
| Cell A | 0.18 | 0.75 |
| Cell B | 0.22 | 0.52 |
| Cell C | 0.14 | 0.84 |
| Cell D | 0.31 | 0.75 |
| Cell E | 0.42 | 0.75 |
| Cell F | 0.15 | 0.93 |
| Cell G | 0.17 | 0.75 |
| Cell H | 0.23 | 0.75 |
| Comparative | 0.64 | 0.27 |
| Cell 1 | | |
| Comparative | 0.64 | 0.75 |
| Cell 2 | | |
| Comparative | 0.18 | 0.27 |
| Cell 3 | | |

(3) Durability Using 4 M Methanol (Measurement of Power Density Retention Rate)

An aqueous 4M methanol solution was supplied as the fuel to the anode at a flow rate of 0.37 cc/min, while air was supplied as the oxidant to the cathode at a flow rate of 0.26 L/min. Each cell was operated continuously at a constant current density of 200 mA/cm². The cell temperature during power generation was set at 60° C.

From the voltage value measured at 4 hours after the start of power generation, an electric power density was calculated. The obtained value was used as an initial power density. Thereafter, from the voltage value measured at 5000 hours after the start of power generation, an electric power density was calculated.

The ratio of the power density after 5000-hour operation to the initial power density was defined as a power density retention rate (%). The results are shown in Table 5.

(4) Durability Using 1 M Methanol (Measurement of Power Density Retention Rate)

An aqueous 1M methanol solution was supplied as the fuel to the anode at a flow rate of 1.48 cc/min, while air was supplied as the oxidant to the cathode at a flow rate of 0.26 L/min. Cell A and Comparative Cell 1 were operated continuously at a constant current density of 200 mA/cm². The cell temperature during power generation was set at 70° C.

From the voltage value measured at 4 hours after the start of power generation, an electric power density was calculated. The obtained value was used as an initial power density. Thereafter, from the voltage value measured at 5000 hours after power generation, an electric power density was calculated.

The ratio of the power density after 5000-hour operation to the initial power density was defined as a power density retention rate (%). The results are shown in Table 6.

(5) Ru Deposition Amount at Cathode after Durability Evaluation

The anode diffusion layer and the anode catalyst layer were removed from the MEA after durability evaluation as described in (3) and (4). The resultant MEA was heated to 700° C. in an oxygen gas flow, to be burned. Sodium peroxide was added to the burnt residue to fuse them, to which ion-exchange water was added and heat-fused. Hydrochloric acid and nitric acid were added thereto to a fixed volume, which was used as a measurement sample. The Ru amount at the cathode was measured by ICP emission spectrometry. The obtained value was divided by the electrode area on the cathode side, to determine a Ru deposition amount at the cathode. The results are shown in Tables 5 and 6.

TABLE 5

| | Initial power | Power density | Ru deposition |
|---|---|---|---|
| | density | retention rate | amount |
| | (mW/cm²) | (%) | (μg/cm²) |
| Cell A | 88 | 95 | 21 |
| Cell B | 85 | 92 | 26 |
| Cell C | 87 | 94 | 18 |
| Cell D | 84 | 85 | 44 |
| Cell E | 82 | 80 | 51 |
| Cell F | 84 | 88 | 17 |
| Cell G | 76 | 91 | 32 |
| Cell H | 83 | 90 | 34 |
| Comparative | 56 | 42 | 72 |
| Cell 1 | | | |
| Comparative | 68 | 67 | 64 |
| Cell 2 | | | |
| Comparative | 74 | 58 | 24 |
| Cell 3 | | | |

TABLE 6

| | Initial power | Power density | Ru deposition |
|---|---|---|---|
| | density | retention rate | amount |
| | (mW/cm²) | (%) | (μg/cm²) |
| Cell A | 92 | 98 | 17 |
| Comparative | 68 | 53 | 61 |
| Cell 1 | | | |

As shown in Table 5, Cells A to H exhibited high power density retention rates and small Ru deposition amounts at the cathode after durability evaluation. In Cells A to H, the weight ratio M₁ of the first polymer electrolyte in the anode catalyst layer was relatively high. Presumably because of this, the deaggregation of the particulate first conductive carbon was facilitated, increasing the electrode reaction area of the anode catalyst. As a result, a local increase in anode potential was unlikely to occur, and a smaller amount of Ru dissolved, leading to a small Ru deposition amount. Furthermore, in Cells A to H, the weight ratio M₂ of the second polymer electrolyte in the cathode catalyst layer was relatively low. Presumably because of this, the swelling of the second polymer electrolyte due to MCO was suppressed, and the porosity of the cathode catalyst layer was sufficiently ensured. As a result, the diffusibility of oxidant at the cathode catalyst layer was improved, leading to an excellent power density retention rate.

In particular, Cells A to C exhibited remarkably improved initial power densities and the power retention rates. This is presumably because in Cells A to C, M₁ and M₂ were controlled in a well-balanced manner, which resulted in remarkably small Ru deposition amounts at the cathode, and in significantly suppressed reduction in proton conductivity.

On the other hand, Comparative Cells 1 to 3 exhibited remarkably low power density retention rates, as compared with Cells A to H.

In Comparative Cell 1, M₁ was lower than M₂, and presumably because of this, the first particulate conductive carbon was not deaggregated sufficiently, to decrease the electrode reaction area of the anode catalyst. Presumably as a result, a local increase in anode potential occurred, the Ru deposition amount at the cathode increased, and the oxygen reduction performance of Pt deteriorated. Moreover, the second polymer electrolyte excessively swelled due to MCO to lower the porosity of the cathode catalyst layer, and thus to slow the diffusion of oxidant, and as a result, the power density retention rate was significantly lowered.

In Comparative Cell 2, the balance between the compositions of the anode catalyst layer and the cathode catalyst layer was lost, i.e., the weight ratio of the first polymer electrolyte in the anode catalyst layer was low and was equal to the weight ratio of the second polymer electrolyte in the cathode catalyst layer. Presumably because of this, the first particulate conductive carbon in the anode catalyst layer was not deaggregated, to decrease the electrode reaction area of the anode catalyst. Consequently, a local increase in anode potential occurred, and the Ru deposition amount at the cathode increased, which caused the deterioration in oxygen reduction performance of Pt to proceed. As a result, the diffusion of oxidant at the cathode catalyst layer was slowed, and the power density retention rate was significantly lowered.

In Comparative Cell 3, the balance between the compositions of the anode catalyst layer and the cathode catalyst layer was lost, i.e., the weight ratio of the second polymer electrolyte in the cathode catalyst layer was high and was equal to the weight ratio of the first polymer electrolyte in the anode catalyst layer. Presumably because of this, the second polymer electrolyte excessively swelled due to MCO, to decrease the pore volume of the cathode catalyst layer. As a result, the diffusion of oxidant at the cathode catalyst layer was slowed, and the power density retention rate was lowered.

As shown in Tables 5 and 6, the difference in power density retention rate between Cell A and Comparative Cell 1 in the case of using an aqueous 4M methanol solution as the fuel was larger than that in the case of using an aqueous 1M methanol solution. This indicates that the effect of the present invention is more remarkable when using an aqueous methanol solution with high concentration.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The membrane electrode assembly for a direct oxidation fuel cell and the direct oxidation fuel cell using the same according to the present invention have excellent power generation characteristics and durability, and therefore, are useful as, for example, the power source for portable small electronic devices, such as cellular phones, notebook personal computers, and digital still cameras, or the portable power source to be used as a replacement for an engine generator, in a construction site or disaster site, or for medical equipment. Furthermore, the membrane electrode assembly for a direct oxidation fuel cell and the direct oxidation fuel cell using the same according to the present invention are suitably applicable also to the power source for electric scooters, automobiles, and the like.

### REFERENCE SIGNS LIST

1 Unit cell
10 Electrolyte membrane
11 Anode
12 Cathode
13 Membrane electrode assembly (MEA)
14 Anode-side separator
15 Cathode-side separator
16 Anode catalyst layer
17 Anode diffusion layer
18 Cathode catalyst layer
19 Cathode diffusion layer
20 Fuel flow channel
21 Oxidant flow channel
22 Anode-side gasket
23 Cathode-side gasket
24, 25 Current collector plate
26, 27 Sheet heater
28, 29 Insulator plate
30, 31 End plate
40, 50 Through-pore
40a Throat portion
40b Agglomerated region
51 Silwick reagent
60 Spray coater
61 Tank
62 Catalyst ink
63 Spray gun
64 Stirrer
65 Open/close valve
66 Supply pipe
67 Gas pressure regulator
68 Gas flow regulator
69 Actuator
70 Coating area
71 Mask
72 Heater

### [FIG. 1]

### [FIG. 2]

### [FIG. 3]

### (a) Region I

### (b) Region II

### (c) Region III

### Air

### [FIG. 4]

Air flow
Air pressure

### [FIG. 5]

### Lw/Ld (%)

Pore diameter (μm)

### [FIG. 6]

Ratio of air flow (%)
Pore diameter (μm)
[FIG. 7]

1. A membrane electrode assembly for a direct oxidation fuel cell, comprising an anode, a cathode, and an electrolyte membrane disposed between the anode and the cathode,
the anode including an anode catalyst layer disposed on one principal surface of the electrolyte membrane, and an anode diffusion layer laminated on the anode catalyst layer,
the anode catalyst layer including a first particulate conductive carbon, an anode catalyst supported on the first particulate conductive carbon, and a first polymer electrolyte,
the cathode including a cathode catalyst layer disposed on the other principal surface of the electrolyte membrane, and a cathode diffusion layer laminated on the cathode catalyst layer,
the cathode catalyst layer including a second particulate conductive carbon, a cathode catalyst supported on the second particulate conductive carbon, and a second polymer electrolyte, and
a weight ratio M₁ of the first polymer electrolyte in the anode catalyst layer being higher than a weight ratio M₂ of the second polymer electrolyte in the cathode catalyst layer.

2. The membrane electrode assembly for a direct oxidation fuel cell in accordance with claim 1, wherein said M₁ is 26 to 35 wt %.

3. The membrane electrode assembly for a direct oxidation fuel cell in accordance with claim 1, wherein a difference (M₁−M₂) between said M₁ and said M₂ is 4 to 16 wt %.

4. The membrane electrode assembly for a direct oxidation fuel cell in accordance with claim 1, wherein a difference |(IEC₁−IEC₂)| between an ion exchange capacity IEC₁ of the first polymer electrolyte and an ion exchange capacity IEC₂ of the second polymer electrolyte is equal to or less than 0.2 meg/g.

5. The membrane electrode assembly for a direct oxidation fuel cell in accordance with claim 4, wherein said IEC₁ and said IEC₂ are each 0.9 to 1.1 meg/g.

6. The membrane electrode assembly for a direct oxidation fuel cell in accordance with claim 1, wherein at least one of the first polymer electrolyte and the second polymer electrolyte is a perfluorocarbon sulfonic acid polymer.

7. The membrane electrode assembly for a direct oxidation fuel cell in accordance with claim 1, wherein an amount of the anode catalyst in the anode catalyst layer per projected unit area is 1 to 4 mg/cm².

8. The membrane electrode assembly for a direct oxidation fuel cell in accordance with claim 1, wherein the anode catalyst layer has a plurality of through pores, and has a pore throat size distribution in which a cumulative ratio of pore throat sizes of 0.5 μm or less is 10 to 20%, the pore size distribution being measured by a half-dry/bubble-point method.

9. The membrane electrode assembly for a direct oxidation fuel cell in accordance with claim 8, wherein in the pore throat size distribution, a largest pore diameter of the through pores is 2 to 3 μm, and a mean flow pore diameter of the through pores is 0.8 to 1.2 μm.

10. The membrane electrode assembly for a direct oxidation fuel cell in accordance with claim 1, wherein the anode catalyst layer has an air permeability of 0.05 to 0.08 L/(min·cm²·kPa).

11. The membrane electrode assembly for a direct oxidation fuel cell in accordance with claim 1, wherein the anode catalyst layer has a proton conductive resistance of 0.05 to 0.25Ω·cm².

12. The membrane electrode assembly for a direct oxidation fuel cell in accordance with claim 1, wherein the cathode catalyst layer has a plurality of through pores, and has a pore throat size distribution in which a cumulative ratio of pore throat sizes of 0.5 μm or less is 2 to 10%, the pore size distribution being measured by a half-dry/bubble-point method.

13. The membrane electrode assembly for a direct oxidation fuel cell in accordance with claim 12, wherein in the pore throat size distribution, a largest pore diameter of the through pores is 2 to 3 μm, and a mean flow pore diameter of the through pores is 0.8 to 1.2 μm.

14. The membrane electrode assembly for a direct oxidation fuel cell in accordance with claim 1, wherein the cathode catalyst layer has an air permeability of 0.02 to 0.05 L/(min·cm²·kPa).

15. The membrane electrode assembly for a direct oxidation fuel cell in accordance with claim 1, wherein the cathode catalyst layer has a proton conductive resistance of 0.5 to 1Ω·cm².

16. A direct oxidation fuel cell comprising at least one unit cell which includes the membrane electrode assembly of claim 1 for a direct oxidation fuel cell, an anode-side separator in contact with the anode, and a cathode-side separator in contact with the cathode.
